(19) United States
(12) Patent Application Publication
(10) Pub. No.: US 2017/0060644 A1
(43) Pub. Date: Mar. 2, 2017

(54) IMAGE PROCESSING APPARATUS, CONTROL TASK ALLOCATION METHOD, AND RECORDING MEDIUM

(71) Applicant: Konica Minolta, Inc., Tokyo (JP)

(72) Inventor: Kazuto TANAKA, Ichikawa-shi (JP)

(73) Assignee: Konica Minolta, Inc., Tokyo (JP)

(21) Appl. No.: 15/243,136

(22) Filed: Aug. 22, 2016

(30) Foreign Application Priority Data
Aug. 25, 2015 (JP) 2015-165387

(51) Int. Cl. G06F 9/50

(52) U.S. Cl. CPC G06F 9/5094; G06F 9/5027

(57) ABSTRACT

An image processing apparatus includes: a multi-core CPU having multiple cores; a selector that selects either a first mode or a second mode with respect to allocation of control tasks to the cores of the multi-core CPU; and an allocator that allocates control tasks to the cores of the multi-core CPU by the symmetric multiprocessing technology when the first mode is selected by the selector, and that allocates control tasks to the cores of the multi-core CPU by the asymmetric multiprocessing technology when the second mode is selected by the selector.

This application claims priority under 35 U.S.C. §119 to Japanese Patent Application No. 2015-165387 filed on Aug. 25, 2015, the entire disclosure of which is incorporated herein by reference in its entirety.

### BACKGROUND OF THE INVENTION

Field of the Invention

The present invention relates to: an image processing apparatus such as a multifunctional machine having multiple functions, e.g., printer function, facsimile function, and scanner function; a control task allocation method for the image processing apparatus; and a recording medium.

Description of the Related Art

The following description sets forth the inventor's knowledge of related art and problems therein and should not be construed as an admission of knowledge in the prior art.

While performances of recent hardware such as recent CPUs have been updated, their prices have fallen significantly. It is a recent trend to reduce the costs of hardware development by sharing hardware resources for high-end image processing apparatuses with low-end image processing apparatuses having features of compact size and reasonable speed.

Now it is not uncommon to use identical hardware in both high-end and low-end image processing apparatuses. To further reduce the costs of development, it may be good to share firmware for high-end image processing apparatuses with low-end image processing apparatuses.

However, high performances are essentially required for high-end image processing apparatuses; one of them is, for example, multi-job function for executing multiple jobs in parallel. In contrast, power saving is essentially required for low-end image processing apparatuses; obviously, high performances such as multi-job function are hardly required for them. Because of differences in features, it is not adequate to share firmware for high-end image processing apparatuses with low-end image processing apparatuses.

For example, a high-end image processing apparatus has firmware in its multi-core CPU consisting of multiple cores. With this firmware, the high-end image processing apparatus performs control task allocation such that the use of available cores can be optimized for fast processing. In contrast, a low-end image processing apparatus has firmware identical to that for the high-end image processing apparatus, in its multi-core CPU. With this firmware, the low-end image processing apparatus performs control task allocation such that the use of available cores can be optimized for fast processing, although high performances are hardly required for them. As a result, the low-end image processing apparatus uselessly allows dynamic power consumption because the “clock gating” function for stopping the clocks is substantially disabled.

This example represents a compelling need for firmware configured to switch the operation mode between high performance mode and power saving mode in order to use identical firmware in both high-end and low-end image processing apparatuses.

Japanese Unexamined Patent Publication No. 2010-160565 discloses a task scheduling apparatus that is configured to schedule multiple tasks to be executed by a system composed of multiple processors. The task scheduling apparatus is provided with a scheduler that estimates the processing load caused by each task prior to multiple task processing, further estimates the use rate of each processor with reference to the estimated processing load, and turns off power to any processor that is estimated to be in an idle state.

Japanese Unexamined Patent Publication No. 2010-277300 discloses a power saving device for a distributed multiprocessor system, and the distributed multiprocessor system consists of multiple processors and is capable of handling performance-guaranteed tasks and performance-non-guaranteed tasks. The distributed multiprocessor system is provided with: (a) an allocating portion that performs task allocation such that as small number of processors as possible are used for the performance-guaranteed tasks, with reference to the relations between: (i) values of performances of the respective performance-guaranteed tasks to be allocated; and (ii) values of processing capacities required by the respective performance-guaranteed tasks, the processing capacities including the time of real-time performances; and (b) a status switching portion that switches the status of each unused processor to power saving status, the each unused processor having a performance-non-guaranteed task allocated by the allocating portion.

Either of the techniques described in the publications above, however, does not relate to firmware configured to switch the operation mode between different modes, e.g., high performance mode and power saving mode, and either of the techniques does not allow the use of identical firmware in both high-end and low-end image processing apparatuses.

### SUMMARY OF THE INVENTION

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

A first aspect of the present invention relates to an image processing apparatus including:

a multi-core CPU having multiple cores;

a selector that selects either a first mode or a second mode with respect to allocation of control tasks to the cores of the multi-core CPU; and

an allocator that allocates control tasks to the cores of the multi-core CPU by the symmetric multiprocessing technology when the first mode is selected by the selector and that allocates control tasks to the cores of the multi-core CPU by the asymmetric multiprocessing technology when the second mode is selected by the selector.

A second aspect of the present invention relates to a control task allocation method for an image processing apparatus, the image processing apparatus including a multi-core CPU having multiple cores, the control task allocation method including:

selecting either a first mode or a second mode with respect to allocation of control tasks to the cores of the multi-core CPU; and

allocating control tasks to the cores of the multi-core CPU by the symmetric multiprocessing technology when the first mode is selected, and allocating control tasks to the cores of the multi-core CPU by the asymmetric multiprocessing technology when the second mode is selected.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying drawings, in which:

FIG. 1 is a block diagram illustrating a configuration of an image processing apparatus according to one embodiment of the present invention;

FIG. 2A indicates a table containing the maximum processing loads (occupation rates of CPU) required by control tasks when the full processing capacities of the cores 0 to 3 of a CPU 11 are 1.0; FIG. 2B is a load level indicator indicating the levels of the maximum processing load caused by a control task for later reference on FIG. 2C and the following figures; FIG. 2C is an explanatory view of a control task allocation method using the symmetric multiprocessing technology, to be implemented when the image processing apparatus starts up in high performance mode (when the image processing apparatus enters an idle state);

FIG. 3A is an explanatory view of a control task allocation method to be implemented when a copy job is executed in high performance mode; FIG. 3B is an explanatory view of a control task allocation method to be implemented when a PC print job is executed in high performance mode; FIG. 3C is an explanatory view of a control task allocation method to be implemented when a scan-to-network job is executed in high performance mode;

FIG. 4A is an explanatory view of a control task allocation method to be implemented when a copy job and a scan-to-network job are executed in high performance mode; FIG. 4B is an explanatory view of a control task allocation method to be implemented when a copy job and a PC print job are executed in high performance mode; FIG. 4C is an explanatory view of a control task allocation method to be implemented when a PC print job and a scan-to-network job are executed in high performance mode;

FIG. 5 is an explanatory view of a control task allocation method using the asymmetric multiprocessing technology, to be implemented when the image processing apparatus starts up in power saving mode (when the image processing apparatus enters an idle state);

FIG. 6A is an explanatory view of a control task allocation method to be implemented when a copy job is executed in power saving mode; FIG. 6B is an explanatory view of a control task allocation method to be implemented when a PC print job is executed in power saving mode; FIG. 6C is an explanatory view of a control task allocation method to be implemented when a scan-to-network job is executed in power saving mode;

FIG. 7 is a flowchart indicating how the image processing apparatus allocates control tasks when starting up;

FIG. 8 is a flowchart indicating how the image processing apparatus allocates control tasks when executing a job; and

FIG. 9 is a flowchart indicating how the image processing apparatus allocates control tasks when completing a job.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, one embodiment of the present invention will be described with reference to the accompanying drawings.

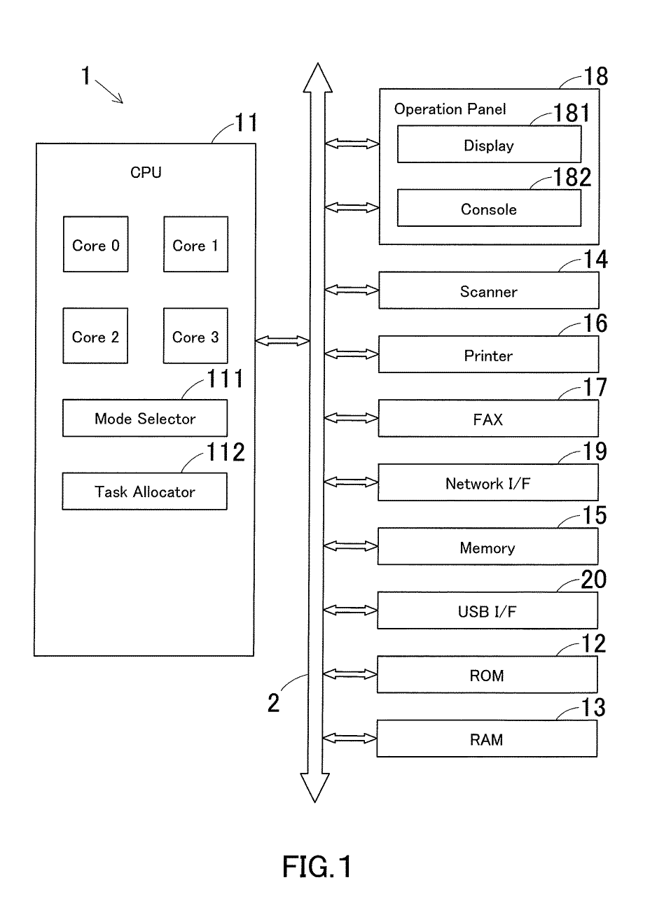

FIG. 1 is a block diagram illustrating a configuration of an image processing apparatus 1 according to one embodiment of the present invention. In this embodiment, a multifunctional machine having various functions such as copier function, printer function, facsimile function, and scanner function is employed as the image processing apparatus 1.

The image processing apparatus 1 is essentially provided with a CPU 11, a ROM 12, a RAM 13, a scanner 14, a memory 15, a printer 16, a facsimile (FAX) 17, an operation panel 18, a network interface (network I/F) 19, and an USB interface (USB I/F) 20. The CPU 11 is connected to the other components through a bus network.

The CPU 11 serves as a controller that allows basic functions of the image processing apparatus 1, such as copier function, printer function, scanner function, and facsimile function, to be available by controlling the image processing apparatus 1 in a unified and systematic manner. The CPU 11 is a multi-core CPU, and has multiple cores. In this embodiment, the CPU 11 has four cores: cores 0 to 3. The CPU 11 is provided with a mode selector 111 and a task allocator 112; the mode selector 111 and the task allocator 112 functionally constitute the CPU 11 by firmware running on the CPU 11.

The mode selector 111 selects either high performance mode or power saving mode as instructed by a user, for example. The mode selector 111 further sets a task allocation method suitable for the selected mode.

The task allocator 112 allocates control tasks to the cores 0 to 3 of the CPU 11 by the task allocation method selected by the mode selector 111. The task allocation control will be later described in detail.

The ROM 12 is a memory that stores operation programs constituting firmware of the CPU 11, and other data.

The RAM 13 is a memory that provides a workspace for the CPU 11 to execute an operation program.

The scanner 14 is an image reader portion that reads images on a document put on a platen (not shown in this figure) to output an image data object therefrom.

The memory 15 is comprised of a non-volatile memory device such as a hard disk drive (HDD) or a solid state drive (SSD). The memory 15 stores an operating system (OS), image data objects obtained from a document by the scanner 14, and other data.

The printer 16 prints images in a specified print mode, using an image data object obtained from a document by the scanner 14, print data received externally, and other data. The FAX 17 controls facsimile transmission and receiving.

The operation panel 18 serves for input for various operations. The operation panel 18 is provided with: a display 181 that consists of a touch-screen liquid-crystal display, for example, and that displays messages and operation screens; and a console 182 having a numeric keypad, a start key, a stop key, and other keys.

The network I/F 19 maintains data transmission and receipt by controlling communications with external apparatuses on the network, such as other image processing apparatuses and user terminals.

The USB I/F 20 is a connector for connection to an USB flash memory (not shown in this figure).

Hereinafter, a control task allocation method will be described. In this embodiment, when the mode selector 111 selects high performance mode, the task allocator 112 then allocates control tasks to the cores 0 to 3 of the CPU 11 using the symmetric multiprocessing (SMP) technology. That is, the task allocator 112 equally allocates control tasks to all the four cores, the cores 0 to 3, in order to optimize the use of available cores. This task allocation method achieves high performance by the sacrifice of power consumption, since power is necessarily supplied to all the four cores, the cores 0 to 4.

Hereinafter, a control task allocation method using the symmetric multiprocessing technology will be described in detail with reference to some drawings.

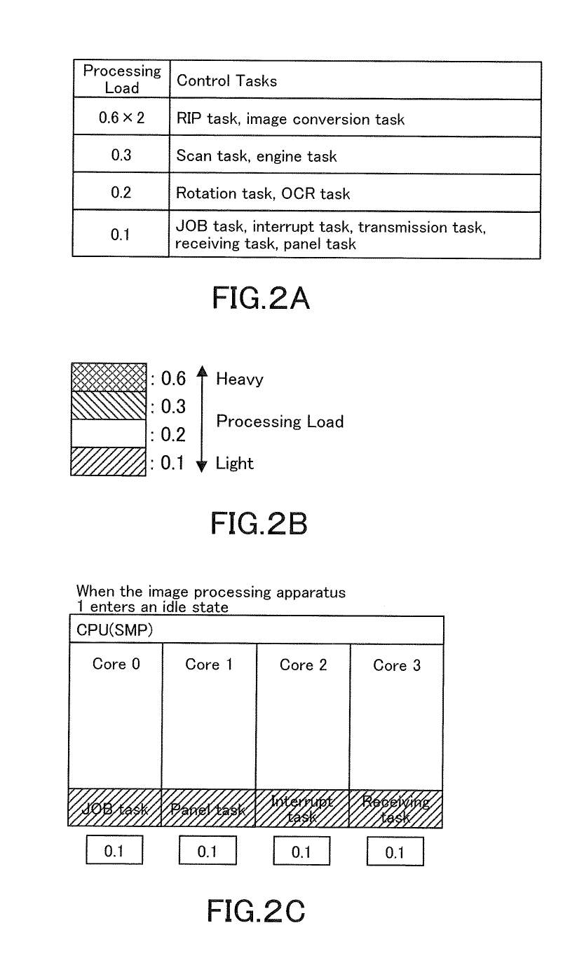

FIG. 2A indicates a table containing the maximum processing loads (occupation rates of CPU) required by control tasks when the full processing capacities of the cores 0 to 3 of the CPU 11 all are 1.0. In this embodiment, the maximum processing loads caused by the following control tasks are all 0.1: a job (JOB) task, an interrupt task, a transmission task, a receiving task, and a panel task; the maximum processing loads caused by the following control tasks are all 0.2: a rotation task and a character recognition (OCR) task; the maximum processing loads caused by the following control tasks are all 0.3: a scan task and an engine task; the maximum processing loads caused by the following control tasks are all 0.6×2: a raster image processing (RIP) task and an image conversion task.

The job task is a control task relating to the initiation of a job, the rotation task is a control task relating to the rotation of a photoconductor drum, a paper conveyance roller, and other portions, the RIP task is a control task for generating a raster image (bitmap image), and the image conversion task is a control task for converting image data to another electronic file format. These control tasks, however, are not limited to this embodiment.

FIG. 2B is a load level indicator indicating the levels of the maximum processing load caused by a control task for later reference on FIG. 2C and the following figures. The control tasks requiring a maximum processing load of 0.1 will be marked with diagonal lines drawn from top right to bottom left; the control tasks requiring a maximum processing load of 0.2 will be marked with blank; the control tasks requiring a maximum processing load of 0.3 will be marked with diagonal lines drawn from top left to bottom right; and the control tasks requiring a maximum processing load of 0.6 will be marked with a criss-cross grid of diagonal lines.

FIG. 2C is an explanatory view of a control task allocation method using the symmetric multiprocessing technology, to be implemented when the image processing apparatus 1 starts up in high performance mode (when the image processing apparatus 1 enters an idle state).

Upon startup of the image processing apparatus 1, a job task requiring a maximum processing load of 0.1 is allocated to the core 0, a panel task requiring a maximum processing load of 0.1 is allocated to the core 1, an interrupt task requiring a maximum processing load of 0.1 is allocated to the core 2, and a receiving task requiring a maximum processing load of 0.1 is allocated to the core 3. The following control tasks are required for detection of a job being input: a JOB task, a panel task, an interrupt task, and a receiving task. The maximum processing loads caused by all control tasks allocated to one core are summed up to obtain a value, which is shown under the task mapping of each core. The sum of the maximum processing loads on each core is 0.1. That is, the cores 0 to 3 are all far from reaching their full processing capacities. Upon startup, power is supplied to all the cores 0 to 3.

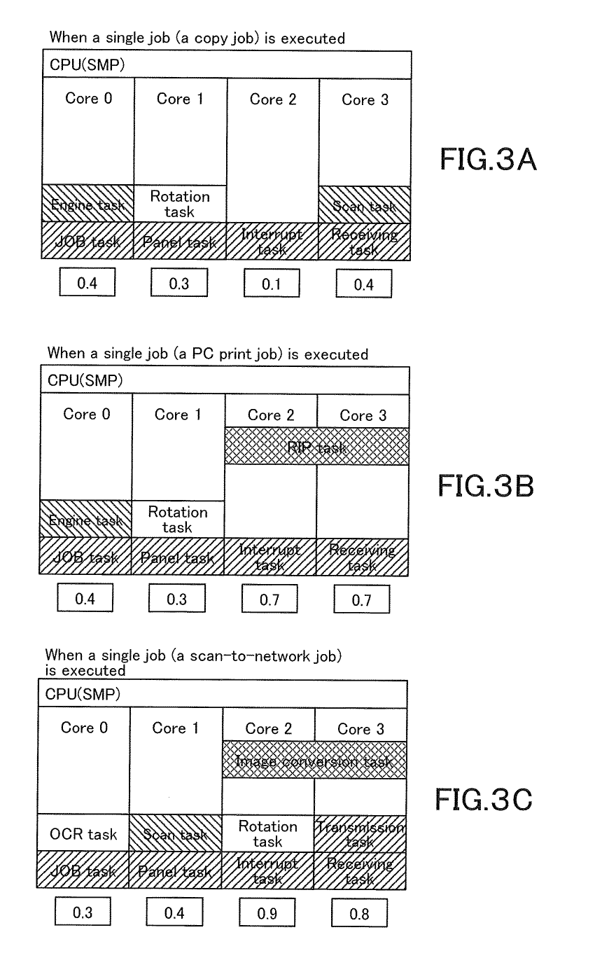

FIG. 3A is an explanatory view of a control task allocation method to be implemented when a single job (a copy job) is executed. When a copy job is executed, an engine task, a rotation task, and a scan task are further allocated in a manner similar to the way the control tasks are allocated when the image processing apparatus 1 enters an idle state as referred to FIG. 2C. In this embodiment, an engine task is allocated to the core 0, a rotation task is allocated to the core 1, and a scan task is allocated to the core 3. As a result, the sum of the maximum processing loads on the core 0 is 0.4, the sum of the maximum processing loads on the core 1 is 0.3, the sum of the maximum processing loads on the core 2 is 0.1, and the sum of the maximum processing loads on the core 3 is 0.4. That is, the control tasks are allocated in such a manner that the loads are distributed, and the cores 0 to 3 are all still far from reaching their full capacities.

FIG. 3B is an explanatory view of a control task allocation method to be implemented when another single job (a PC print job) is executed. A PC print job is a job for printing print data received from a user terminal consisting of a personal computer, for example. When a PC print job is executed, an engine task, a rotation task, and a RIP task are further allocated in a manner similar to the way the control tasks are allocated when the image processing apparatus 1 enters an idle state as referred to FIG. 2C. In this embodiment, an engine task is allocated to the core 0, a rotation task is allocated to the core 1, and a RIP task is allocated to both the cores 2 and 3. As a result, the sum of the maximum processing loads on the core 0 is 0.4, the sum of the maximum processing loads on the core 1 is 0.3, the sum of the maximum processing loads on the core 2 is 0.7, and the sum of the maximum processing loads on the core 3 is 0.7.

FIG. 3C is an explanatory view of a control task allocation method to be implemented when yet another single job (a scan-to-network job) is executed. A scan-to-network job is a job for scanning a document by the scanner 14 and transmitting image data obtained by the scanner 14 to a specified address. When a scan-to-network job is executed, an OCR task, a scan task, a rotation task, a transmission task, and an image conversion task are further allocated in a manner similar to the way the control tasks are allocated when the image processing apparatus 1 enters an idle state as referred to FIG. 2C. In this embodiment, an OCR task is allocated to the core 0, a scan task is allocated to the core 1, a rotation task and an image conversion task are allocated to the core 2, and a transmission task and another image conversion task are allocated to the core 3. As a result, the sum of the maximum processing loads on the core 0 is 0.3, the sum of the maximum processing loads on the core 1 is 0.4, the sum of the maximum processing loads on the core 2 is 0.9, and the sum of the maximum processing loads on the core 3 is 0.8.

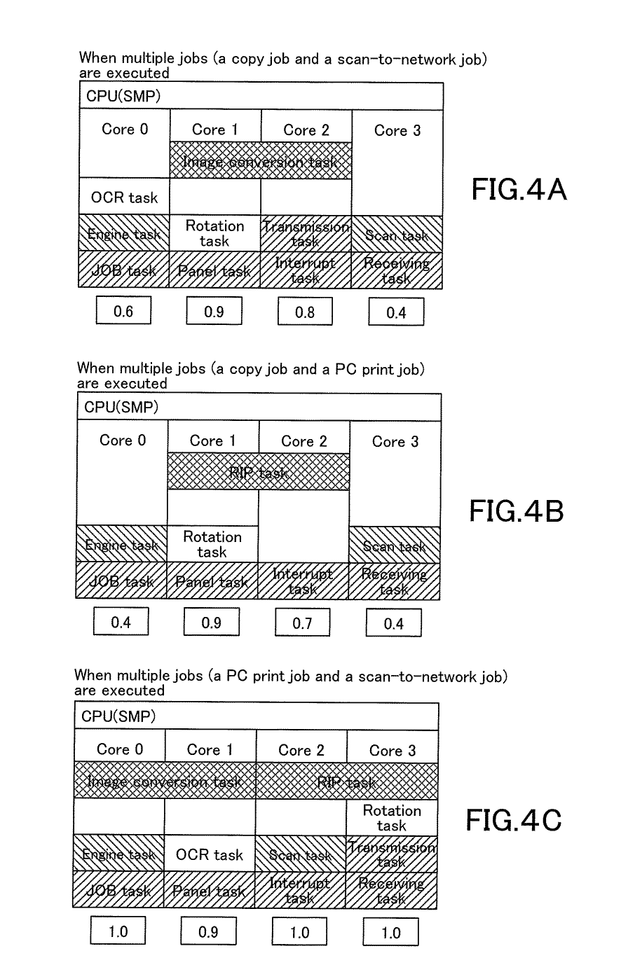

FIG. 4A is an explanatory view of a control task allocation method to be implemented when multiple jobs (in this example, a copy job and a scan-to-network job) are executed in parallel. When a copy job and a scan-to-network job are executed, an engine task, a rotation task, and a scan task, which are required for a copy job, and an OCR task, a transmission task, and an image conversion task, which are still required for a scan-to-network job, are further allocated in a manner similar to the way the control tasks are allocated when the image processing apparatus 1 enters an idle state as referred to FIG. 2C. In this embodiment, an engine task and an OCR task are allocated to the core 0, a rotation task and an image conversion task are allocated to the core 1, a transmission task and another image conversion task are allocated to the core 2, and a scan task is allocated to the core 3. As a result, the sum of the maximum processing loads on the core 0 is 0.6, the sum of the maximum processing loads on the core 1 is 0.9, the sum of the maximum processing loads on the core 2 is 0.8, and the sum of the maximum processing loads on the core 3 is 0.4. Also in the case of multiple jobs, the control tasks are allocated to the cores 0 to 3 in such a manner that the loads are distributed.

FIG. 4B is an explanatory view of a control task allocation method to be implemented when other multiple jobs (in this example, a copy job and a PC print job) are executed. When a copy job and a PC print job are executed, an engine task, a rotation task, and a scan task, which are required for a copy job, and a RIP task, which is still required for a PC print job, are further allocated in a manner similar to the way the control tasks are allocated when the image processing apparatus 1 enters an idle state as referred to FIG. 2C. In this embodiment, an engine task is allocated to the core 0, a rotation task and a RIP task are allocated to the core 1, another RIP task is allocated to the core 2, and a scan task is allocated to the core 3. As a result, the sum of the maximum processing loads on the core 0 is 0.4, the sum of the maximum processing loads on the core 1 is 0.9, the sum of the maximum processing loads on the core 2 is 0.7, and the sum of the maximum processing loads on the core 3 is 0.4.

FIG. 4C is an explanatory view of a control task allocation method to be implemented when yet other multiple jobs (in this example, a PC print job and a scan-to-network job) are executed. When a PC print job and a scan-to-network job are executed, an engine task, a rotation task, and a RIP task, which are required for a PC print job, and an OCR task, an engine task, a transmission task, and an image conversion task, which are still required for a scan-to-network job, are further allocated in a manner similar to the way the control tasks are allocated when the image processing apparatus 1 enters an idle state as referred to FIG. 2C. In this embodiment, an engine task and an image conversion task are allocated to the core 0, an OCR task and another image conversion task are allocated to the core 1, a scan task and a RIP task are allocated to the core 2, and a transmission task, a rotation task, and another RIP task are allocated to the core 3. As a result, the sum of the maximum processing loads on the core 0 is 1.0, the sum of the maximum processing loads on the core 1 is 0.9, the sum of the maximum processing loads on the core 2 is 1.0, and the sum of the maximum processing loads on the core 3 is 1.0.

In high performance mode, the method using the symmetric multiprocessing technology allows fast allocation of control tasks while ceaselessly supplying power to the cores 0 to 3. This method achieves the use of the full processing capacities of the cores 0 to 3 accordingly. This method is preferred for high-end image processing apparatuses for which high performances such as multi-job function are essentially required.

In another embodiment, when the mode selector 111 selects power saving mode, the task allocator 112 then allocates control tasks to the cores 0 to 3 of the CPU 11 using the asymmetric multiprocessing (AMP) technology. That is, the task allocator 112 allocates control tasks to at least one of the cores 0 to 3, which is specified in advance. While power is supplied to the at least one specified core, no power is supplied to the other cores. In contrast to the method using the symmetric multiprocessing technology, this method achieves power saving by the sacrifice of performance.

Hereinafter, a control task allocation method using the asymmetric multiprocessing technology will be described in detail with reference to some drawings.

In a manner similar to the embodiment described with reference to FIG. 2A, the maximum processing loads caused by the following control tasks are all 0.1: a job (JOB) task, an interrupt task, a transmission task, a receiving task, and a panel task; the maximum processing loads caused by the following control tasks are all 0.2: a rotation task and a character recognition (OCR) task; the maximum processing loads caused by the following control tasks are all 0.3: a scan task and an engine task; the maximum processing loads caused by the following control tasks are all 0.6×2: a raster image processing (RIP) task and an image conversion task.

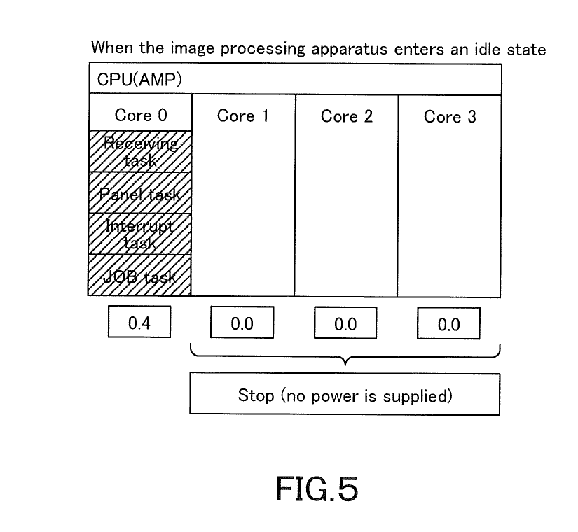

FIG. 5 is an explanatory view of a control task allocation method using the asymmetric multiprocessing technology, to be implemented when the image processing apparatus 1 starts up in power saving mode (when the image processing apparatus 1 enters an idle state).

Upon startup of the image processing apparatus 1, power is supplied only to the core 0, and a job task, a panel task, an interrupt task, and a receiving task are allocated to the core 0. As a result, the sum of the maximum processing loads on the core 0 is 0.4. Meanwhile, no power is supplied and no control task is allocated to the cores 1 to 3. That is, only the core 0 is allowed to operate. This method achieves power saving by the sacrifice of performance.

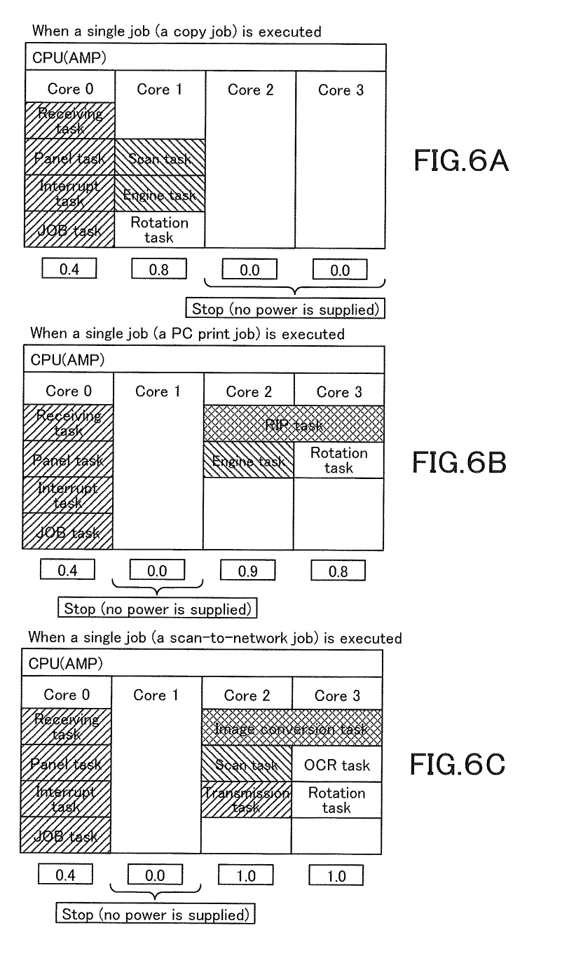

FIG. 6A is an explanatory view of a control task allocation method to be implemented when a single job (a copy job) is executed. When a copy job is executed, an engine task, a rotation task, and a scan task are further allocated in a manner similar to the way the control tasks are allocated when the image processing apparatus 1 enters an idle state as referred to FIG. 5. In this embodiment, while power is supplied to the core 1 as well as to the core 0, an engine task, a rotation task, and a scan task are allocated to the core 1. As a result, the sum of the maximum processing loads on the core 0 stays at 0.4, and the sum of the maximum processing loads on the core 1 is 0.8. Meanwhile, no power is supplied and no control task is allocated to the cores 2 and 3. That is, only the cores 0 and 1 are allowed to operate.

FIG. 6B is an explanatory view of a control task allocation method to be implemented when another single job (a PC print job) is executed. When a PC print job is executed, an engine task, a rotation task, and a RIP task are also allocated in a manner similar to the way the control tasks are allocated when the image processing apparatus 1 enters an idle state as referred to FIG. 5. In this embodiment, while power is supplied to the cores 2 and 3 as well as to the core 0, an engine task and a RIP task are allocated to the core 2, and a rotation task and another RIP task are allocated to the core 3. As a result, the sum of the maximum processing loads on the core 0 is 0.4, the sum of the maximum processing loads on the core 2 is 0.9, and the sum of the maximum processing loads on the core 3 is 0.8. Meanwhile, no power is supplied and no control task is allocated to the core 1. That is, in this case, the cores 0, 2, and 3 are allowed to operate.

FIG. 6C is an explanatory view of a control task allocation method to be implemented when yet another single job (a scan-to-network job) is executed. When a scan-to-network job is executed, an OCR task, a scan task, a rotation task, a transmission task, and an image conversion task are further allocated in a manner similar to the way the control tasks are allocated when the image processing apparatus 1 enters an idle state as referred to FIG. 5. In this embodiment, while power is supplied to the cores 2 and 3 as well as to the core 0, a transmission task, a scan task, and an image conversion task are allocated to the core 2, and a rotation task, an OCR task, and an image conversion are allocated to the core 3. As a result, the sum of the maximum processing loads on the core 0 is 0.4, the sum of the maximum processing loads on the core 2 is 1.0, and the sum of the maximum processing loads on the core 3 is 1.0. Meanwhile, no power is supplied and no control task is allocated to the core 1. That is, in this case, the cores 0, 2, and 3 are allowed to operate.

As described above, the task allocation method using the asymmetric multiprocessing technology allows the use of as small number of cores as possible, while supplying no power to at least one core to be unused. This method achieves power saving accordingly. This method is not useful in execution of multiple jobs since it is possible that, with a single job, at least one of the cores 0 to 3 may reach its full processing capacity. This method is preferred for low-end image processing apparatuses having features of compact size and reasonable speed, for which high performances such as multi-job function are hardly required but power saving is essentially required.

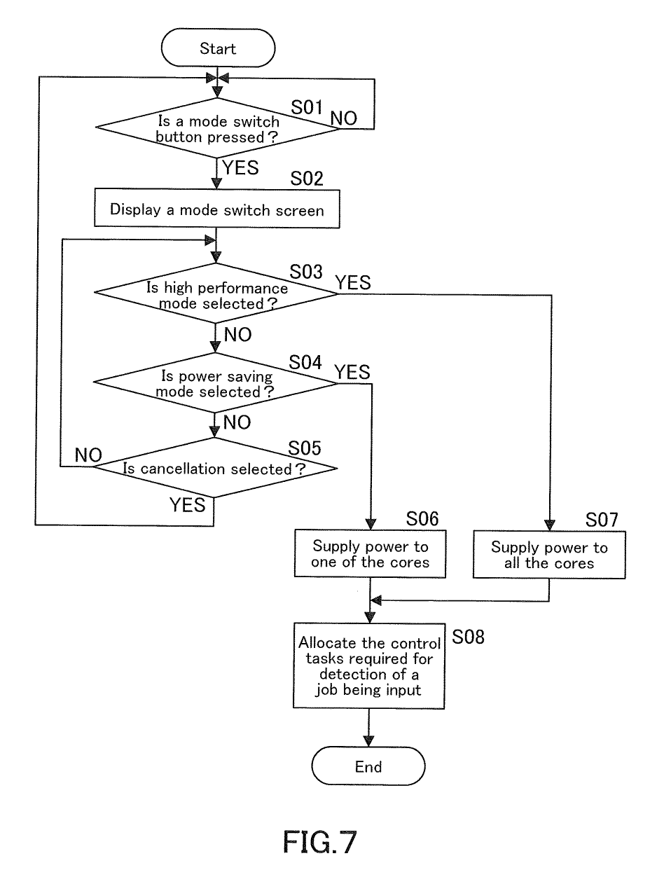

FIG. 7 is a flowchart indicating how the image processing apparatus 1 allocates control tasks when starting up. The routines represented by the flowcharts of FIGS. 7 to 9 are executed by the CPU 11 in accordance with operation programs (firmware) stored on a recording medium such as the ROM 12.

In Step S01, it is judged whether or not a mode switch button is pressed by a user. If it is not pressed (NO in Step S01), the routine waits until it is pressed. If it is pressed (YES in Step S01), a mode switch screen is displayed on the display 181 in Step S02.

In Step S03, it is judged whether or not high performance mode is selected by the user. If high performance mode is selected (YES in Step S03), the routine proceeds to Step S07 in which power is supplied to all the cores 0 to 3. The routine then proceeds to Step S08.

Back to Step S03, if high performance mode is not selected (NO in Step S03), it is then judged in Step S04 whether or not power saving mode is selected by the user. If power saving mode is selected (YES in Step S04), the routine proceeds to Step S06 in which power is supplied to one of the cores 0 to 3, which is specified in advance. For example, power is supplied to the core 0 in Step S06. The routine then proceeds to Step S08.

In Step S08, the control tasks required for detection of a job being input (i.e. a JOB task, a panel task, an interrupt task, and a receiving task) are allocated. The routine then terminates.

Back to Step S04, if power saving mode is not selected (NO in Step S04), it is then judged in Step S05 whether or not cancellation is selected by the user. If cancellation is selected (YES in Step S05), the routine returns to Step S01. If cancellation is not selected (NO in Step S05), the routine returns to Step S03.

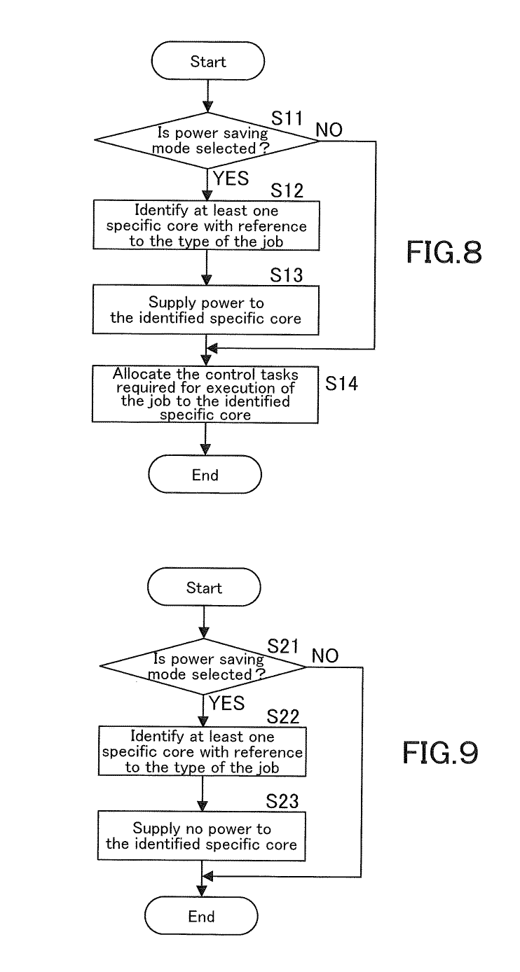

FIG. 8 is a flowchart indicating how the image processing apparatus 1 allocates control tasks when executing a job.

In Step S11, it is judged whether or not power saving mode is selected. If power saving mode is selected (YES in Step S11), at least one specific core is identified with reference to the type of the job in Step S12. In Step S13, power is supplied to the specific core. The routine then proceeds to Step S14.

Back to Step S11, if power saving mode is not selected, in other words, if high performance mode is selected (NO in Step S11), the routine directly proceeds to Step S14.

In Step S14, the control tasks required for execution of the job are allocated to the identified specific core.

FIG. 9 is a flowchart indicating how the image processing apparatus 1 allocates control tasks when completing a job.

In Step S21, it is judged whether or not power saving mode is selected. If power saving mode is selected (YES in Step S21), at least one specific core is identified with reference to the type of the job in Step S22. In Step S23, the power to the identified specific core is stopped.

Back to Step S21, if power saving mode is not selected, in other words, if high performance mode is selected (NO in Step S21), the routine terminates. In this case, power is ceaselessly supplied to all the cores.

As described above, in this embodiment, one set of firmware is configured to switch the operation mode between high performance mode and power saving mode. With this firmware, the image processing apparatus 1 allocates control tasks to the cores 0 to 3 of the CPU 11 using different methods depending on the operation mode. This allows the use of identical firmware in the multi-core CPUs 11 of high-end and low-end image processing apparatuses, which leads to the reduction in the costs of firmware development. As a matter of course, with this one set of firmware in the multi-core CPU 11, one image processing apparatus can perform control task allocation without sacrificing the advantages of both high performance mode and power saving mode.

While one embodiment of the present invention has been described in details herein it should be understood that the present invention is not limited to the foregoing embodiment. For example, the image processing apparatus 1 selects either high performance mode or power saving mode as instructed by a user. Alternatively, the image processing apparatus 1 may prospectively store specified mode information indicating a specified operation mode and select either high performance mode or power saving mode by reading out the specified mode information.

Further alternatively, the image processing apparatus 1 may select either high performance mode or power saving mode by detecting a specific part of it which represents its own product model.

For another example, the available operation modes are high performance mode and power saving mode. Alternatively, they may be other modes such as advanced mode and basic mode.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image processing apparatus comprising:
a multi-core CPU having multiple cores;
a selector that selects either a first mode or a second mode with respect to allocation of control tasks to the cores of the multi-core CPU; and
an allocator that allocates control tasks to the cores of the multi-core CPU by the symmetric multiprocessing technology when the first mode is selected by the selector and that allocates control tasks to the cores of the multi-core CPU by the asymmetric multiprocessing technology when the second mode is selected by the selector.

2. The image processing apparatus according to claim 1, wherein the first mode is high performance mode and the second mode is power saving mode.

3. The image processing apparatus according to claim 1, wherein, when the image processing apparatus starts up in the first mode, the allocator supplies power to all the cores and equally allocates control tasks to the cores, the control tasks being required for detection of a job being input; when the image processing apparatus starts up in the second mode, the allocator supplies power to only one of the cores and allocates control tasks to the core, the control tasks being required for detection of a job being input.

4. The image processing apparatus according to claim 1, wherein, when a job is executed in the first mode, the allocator supplies power to all the cores and equally allocates control tasks to the cores, the control tasks being required for execution of the job; when a job is executed in the second mode, the allocator supplies power to only one or some of the cores being specified in advance for the type of the job, and allocates control tasks to the at least one core, the control tasks being required for execution of the job.

5. The image processing apparatus according to claim 1, wherein, when a job is completed in the first mode, the allocator ceaselessly supplies power to all the cores; when a job is completed in the second mode, the allocator supplies power to only one of the cores, the one core having control tasks allocated thereto, the control tasks being required for detection of a job being input.

6. The image processing apparatus according to claim 1, wherein the selector selects either the first mode or the second mode in accordance with or with reference to any of the following information: (a) a user instruction; (b) specified mode information read out from the image processing apparatus; and (c) information representing the product model of the image processing apparatus.

7. A control task allocation method for an image processing apparatus, the image processing apparatus comprising a multi-core CPU having multiple cores, the control task allocation method comprising:
selecting either a first mode or a second mode with respect to allocation of control tasks to the cores of the multi-core CPU; and
allocating control tasks to the cores of the multi-core CPU by the symmetric multiprocessing technology when the first mode is selected, and allocating control tasks to the cores of the multi-core CPU by the asymmetric multiprocessing technology when the second mode is selected.

8. The control task allocation method according to claim 7, wherein the first mode is high performance mode and the second mode is power saving mode.

9. The control task allocation method according to claim 7, wherein, when the image processing apparatus starts up in the first mode, power is supplied to all the cores and control tasks are equally allocated to the cores, the control tasks being required for detection of a job being input; when the image processing apparatus starts up in the second mode, power is supplied to only one of the cores and allocates control tasks to the core, the control tasks being required for detection of a job being input.

10. The control task allocation method according to claim 7, wherein, when a job is executed in the first mode, power allocated to all the cores and control tasks are equally allocated to the cores, the control tasks being required for execution of the job; when a job is executed in the second mode, power is supplied to only one or some of the cores being specified in advance for the type of the job, and control tasks are allocated to the at least one core, the control tasks being required for execution of the job.

11. The control task allocation method according to claim 7, wherein, when a job is completed in the first mode, power is ceaselessly supplied to all the cores; when a job is completed in the second mode, power is supplied to only one of the cores, the one core having control tasks allocated thereto, the control tasks being required for detection of a job being input.

12. The control task allocation method according to claim 7, wherein either the first mode or the second mode is selected in accordance with or with reference to any of the following information: (a) a user instruction; (b) specified mode information read out from the image processing apparatus; and (c) information representing the product model of the image processing apparatus.

13. A non-transitory computer-readable recording medium storing a control task allocation program for a multi-core CPU of an image processing apparatus to implement the control task allocation method according to claim 7.
